(19) United States
(12) Patent Application Publication
(10) Pub. No.: US 2010/0188198 A1
(43) Pub. Date: Jul. 29, 2010

(54) FUNCTION DISPLAY DEVICE

(75) Inventor: Shuichi TAKEUCHI, Aichi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: KABUSHIKI KAISHA TOKAI RIKA DENKI SEISAKUSHO, Aichi (JP)

(21) Appl. No.: 12/686,270

(22) Filed: Jan. 12, 2010

(30) Foreign Application Priority Data
Jan. 28, 2009 (JP) 2009-016738

(51) Int. Cl. B60Q 1/00

(52) U.S. Cl. 340/425.5

(57) ABSTRACT

A function display device includes an operating portion, a display portion for displaying a function operable by the operating portion, a trigger information generating portion that generates trigger information for displaying the function on the display portion based on movement of an operator with respect to the operating portion, and a control section for controlling the display portion based on the generated trigger information so as to display the function in a region of the display portion easily visible from the operator.

The present application is based on Japanese Patent Application No. 2009-016738 filed on Jan. 28, 2009, the entire contents of which are incorporated herein by reference.

### BACKGROUND OF THE INVENTION

1. Field of the Invention

The present invention relates to a function display device.

2. Description of the Related Art

As a conventional technique, an on-vehicle input device vehicle is known, which is an input system projecting a hierarchical menu for operating plural on-vehicle devices on a windshield in front of the driver's seat by using a head-up display and being operated by a switch provided on a steering while viewing a virtual screen displayed further beyond the windshield, and is characterized in that plural switches provided on the steering are arranged in one-to-one correspondence with options in the hierarchical menu on the displayed virtual screen so as to be adjacent to and so as to surround a center switch (e.g., see JP-A-2006-315562).

This on-vehicle input device is an input system configured to operate a switch provided on the steering while viewing a virtual screen displayed beyond a windshield in front of a driver's seat by using a head-up display, and this allows to operate without removing hands from steering and without taking eyes from the forward view. In addition, plural switches provided on the steering are arranged in one-to-one correspondence with options in the hierarchical menu on the displayed virtual screen so as to be adjacent to and so as to surround a center switch, the center switch is determined as a home position of a finger of the operator, and it is thereby possible to intuitively operate an option to be operated on a display screen without looking at the switch and without large strain on the eyes.

However, the conventional on-vehicle input device has a problem such that the virtual image of a switch which is not intended to be operated is also displayed on the windshield in front of the driver's seat and interrupts the visual field of the operator.

### SUMMARY OF THE INVENTION

Therefore, it is an object of the invention to provide a function display device which displays an image corresponding to a function allocated to an operating portion in a region where the operator does not need to move a line of sight too much.

(1) According to one embodiment of the invention, a function display device comprises:

an operating portion;

a display portion for displaying a function operable by the operating portion;

a trigger information generating portion that generates trigger information for displaying the function on the display portion based on movement of an operator with respect to the operating portion; and

a control section for controlling the display portion based on the generated trigger information so as to display the function in a region of the display portion easily visible from the operator.

In the above embodiment (1), the following modifications and changes can be made.

(i) The movement of the operator with respect to the operating portion includes approach and contact of a hand to the operating portion.

(ii) The operation portion comprises a plurality of functions corresponding to operative positions;

the trigger information generating portion generates the trigger information corresponding to the operative position of the operating portion; and

the control section allows a function corresponding to the operative position to be displayed in the region of the display portion based on the generated trigger information.

(2) According to another embodiment of the invention, an on-vehicle function display device comprises:

an operating portion on a periphery of a driver's seat in a vehicle;

a display portion for displaying a function operable by the operating portion;

a trigger information generating portion that generates trigger information for displaying the function on the display portion based on movement of an operator with respect to the operating portion; and

a control section for controlling the display portion based on the generated trigger information so as to display the function in a region of the display portion easily visible from the operator.

In the above embodiment (2), the following modifications and changes can be made.

(iii) The movement of the operator with respect to the operating portion includes approach and contact of a hand to the operating portion.

(iv) The operation portion has a plurality of functions corresponding to operative positions;

the trigger information generating portion generates the trigger information corresponding to the operative position of the operating portion; and

the control section allows a function corresponding to the operative position to be displayed in the region of the display portion based on the generated trigger information.

(v) The display portion is disposed in an instrument panel.

(vi) The display portion is disposed in a head-up display.

(vii) The trigger information generating portion is disposed on an operating means that is attached to a steering column cover.

(viii) The trigger information generating portion is disposed on a steering base.

Points of the Invention

According to one embodiment of the invention, a function display device is constructed such that it displays functions allocated to each operating portion on a display portion by approach or contact of a hand to each operating portion, so that it is possible to suppress movement of eyes of the operator. Furthermore, the function display device displays an image indicating a function in a region of the display portion within a visual field when viewing an operating lever, so that the function of the operating portion can be viewed with less eye movement.

### BRIEF DESCRIPTION OF THE DRAWINGS

Next, the present invention will be explained in more detail in conjunction with appended drawings, wherein:

FIG. 1 is a schematic view showing inside of a vehicle in a first preferred embodiment of the present invention;

FIG. 2 is a block diagram showing a function display device in the first embodiment of the invention;

FIG. 3 is a side view showing the inside of the vehicle in the first embodiment of the invention;

FIG. 4 is a flow chart in the first embodiment of the invention; and

FIG. 5 is a schematic view showing inside of a vehicle in a second embodiment of the invention.

### DESCRIPTION OF THE PREFERRED EMBODIMENTS

### First Embodiment

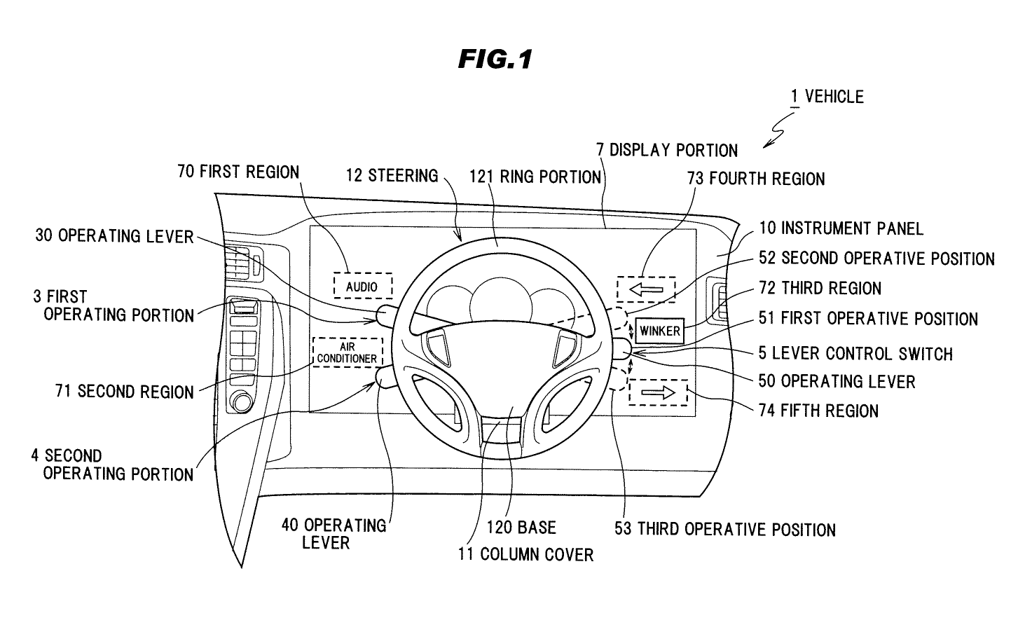

FIG. 1 is a schematic view showing inside of a vehicle in a first embodiment of the invention. FIG. 1 shows a state that an image indicating a main function of a lever control switch is displayed in a third region of a display portion by a contact of an operator to an operating lever of the lever control switch. The case where the function display device of the invention is mounted on a vehicle will be explained in the following embodiment. In addition, a structure inside of a vehicle 1 will be explained.

As shown in FIG. 1, a vehicle 1 is schematically configured to include an instrument panel 10 provided with gauges, etc., thereon, a column cover 11 which is a cover for covering a non-illustrated steering column shaft, and a steering 12 provided at an end portion of the steering column shaft and being capable of changing a traveling direction of the vehicle 1 by rotationally operating.

A display portion 7 is provided on the instrument panel 10. The display portion 7 composes a portion of the below-described function display device.

As shown in FIG. 1, the column cover 11 is provided with first and second operating portions 3 and 4 on left side and a lever control switch 5 on right side. The first operating portion 3, the second operating portion 4 and the lever control switch 5 compose a portion of the below-described function display device.

The steering 12 is schematically configured to include a base 120 provided on a center of the steering 12 and including a horn or various switches, etc., and a ring portion 121 provided having a ring shape around the base 120 and being a portion held by an operator.

Structure of Function Display Device

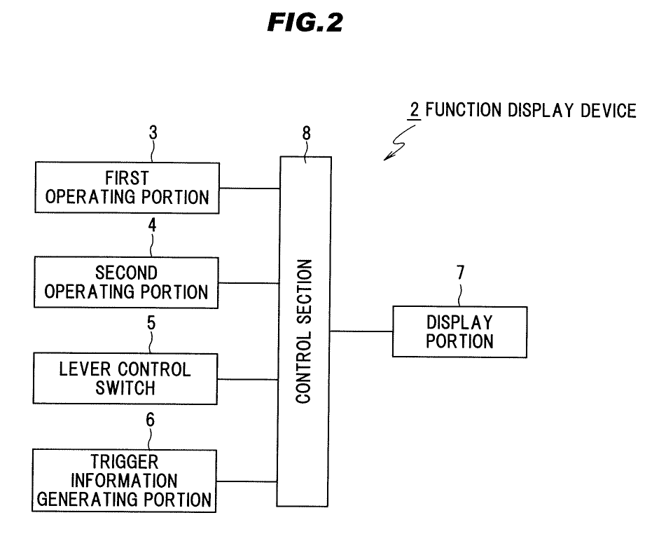

FIG. 2 is a block diagram showing a function display device in the first embodiment of the invention. As shown in FIG. 2, a function display device 2 is, e.g., an operating means of an electronic device mounted on the vehicle 1, and is schematically configured to include the first operating portion 3, the second operating portion 4 and the lever control switch 5 as operating portions to which functions of the electronic device are allocated, the display portion 7 for displaying an image corresponding to the function based on movement with respect to each operating portion (the first operating portion 3, the second operating portion 4 and the lever control switch 5), a trigger information generating portion 6 which generates trigger information for displaying the function on the display portion 7, and a control section 8 which controls the display portion 7 based on the trigger information so as to display the image in a region of the display portion 7 easily visible from the operator.

The first operating portion 3 is provided with an operating lever 30. In addition, the first operating portion 3 is, e.g., one of operating means provided at a distance from an audio device mounted on the vehicle 1, and is capable of operating a function such as a volume control or music selection.

The operating lever 30 is configured to have a movable portion which is, e.g., partially rotatable, and the first operating portion 3 is allowed to operate the volume control or the music selection according to a difference of an operative position due to the rotational operation.

The second operating portion 4 is provided with an operating lever 40. In addition, the second operating portion 4 is, e.g., one of operating means provided at a distance from an air conditioner mounted on the vehicle 1, and is capable of operating a function such as a switching of heating and cooling or temperature control.

The operating lever 40 is configured to have a movable portion which is, e.g., partially rotatable, and the second operating portion 4 is allowed to switch heating and cooling or to control the temperature according to a difference of an operative position due to the rotational operation.

The lever control switch 5 is provided with an operating lever 50. In addition, the lever control switch 5 is, e.g., one of operating means such as a winker unit, width indicators, tail lamps, each switch illumination and head lamps, etc., which are mounted on the vehicle 1, and is capable of operating a function such as turning on/off thereof.

As operative portions of the operating lever 50, the lever control switch 5 has, e.g., a first operative position 51 which is an initial position, a second operative position 52 for lighting a left winker device, and a third operative position 53 for lighting a right winker device.

The operating lever 50 is configured to have a movable portion which is, e.g., partially rotatable, and the lever control switch 5 is allowed to turn on/off the width indicators, the tail lamps, each switch illumination and the head lamps, etc., according to a difference of the operative position due to the rotational operation.

The trigger information generating portion 6 is provided on, e.g., each of the operating levers 30, 40 and 50 of the first operating portion 3, the second operating portion 4 and the lever control switch 5. In addition, the trigger information generating portion 6 generates trigger information based on movement of approach and contact of a hand to each operating portion. In detail, the trigger information generating portion 6 is composed of, e.g., a non-contact sensor for judging on/off based on variation of capacitance in accordance with the approach of the hand, and is configured to detect the contact and approach of the hand as movement with respect to each of the operating levers 30, 40 and 50 and to transmit the trigger information to the control section 8. In addition, the trigger information generating portion 6 is configured to detect the operative position which varies depending on the operation (movement) with respect to each of the operating levers 30, 40 and 50, and to transmit the trigger information to the control section 8.

The trigger information includes, e.g., information of the operating portion to which the hand approaches and contacts, and information of the operative position, etc.

Alternatively, a pressure sensor for detecting pressure by the contact of the hand, an infrared sensor for detecting the approach of the hand and a switch for turning on/off based on the operative position, etc., may be used alone or in combination with the above-mentioned configuration for the trigger information generating portion 6, and it is not limited thereto.

The display portion 7 is composed of, e.g., a liquid crystal display, and can display an image corresponding to a function in an arbitrary region based on the control by the control section 8. The arbitrary region is, e.g., first to fifth regions 70-74 shown in FIG. 1.

Here, dot-lines and a solid line indicating the first to fifth regions 70-74 are shown for explanation and are not practically displayed on the display portion 7. In addition, “audio”, “air conditioner”, “←” and “→” in FIG. 1 are shown for explanation and are not shown when the operator touches the lever control switch 5.

An image of, e.g., “audio” is displayed in the first region 70 in FIG. 1 since the electronic device operable by the first operating portion 3 is an audio device. Furthermore, when the movable portion of the operating lever 30 is rotatably operated, the operable function of the audio device is displayed as an image in the first region 70 based on the operative portion. Meanwhile, an image of, e.g., “air conditioner” is displayed in the second region 71 since the electronic device operable by the second operating portion 4 is an air conditioner. In addition, when the movable portion of the operating lever 40 is rotatably operated, the operable function of the air conditioner is displayed as an image in second region 71 based on the operative portion.

Images corresponding to the functions allocated to the first to third operative positions 51-53 of the lever control switch 5 are displayed in the third to fifth regions 72-74. An image of, e.g., “air conditioner” is displayed in the third region 72 since the electronic device operable is an air conditioner. Meanwhile, an image of, e.g., “←” which corresponds to the second operative position 52 of the operating lever 50 is displayed in the fourth region 73. An image of, e.g., “→” which corresponds to the third operative position 53 of the operating lever 50 is displayed in the fifth region 74.

The above-mentioned images displayed in each region (the first to fifth regions 70-74) are examples, thus, all functions of each operating portion may be displayed, or the functions, etc., may be hierarchically displayed, or a menu may be displayed, and it is not limited thereto.

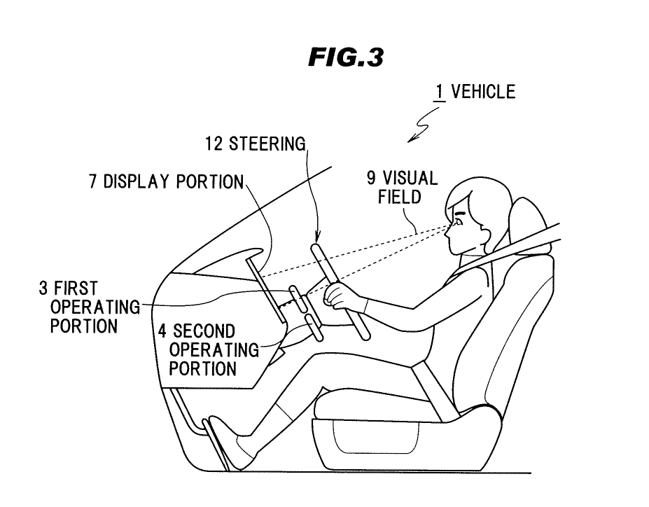

FIG. 3 is a side view showing the inside of the vehicle in the first embodiment of the invention. The control section 8 is composed of, e.g., a CPU (central processing unit). The control section 8 calculates a region easily visible from the operator based on, e.g., the operative portions of each of the operating levers 30, 40 and 50.

Here, as shown in FIG. 3, the region easily visible from the operator is, e.g., a region of the display portion 7 within a visual field 9 of the operator as well as a region which does not become a blind area due to the hand of the operator or the steering 12, etc., at the time that the operator views the operating lever 30 for operating the first operating portion 3.

The region easily visible from the operator may be preliminarily set based on the positions of each of the operating levers 30, 40, 50 and the visual field 9 which is calculated from, e.g., an eye position determined by an average seating height of the operator. Alternatively, the region easily visible from the operator may be calculated by the control section 8 based on the positions of the operating levers 30, 40, 50 and the visual field 9 which is calculated by, e.g., determining an eye position of each operator based on information of each sensor mounted on the vehicle 1, and it is not limited thereto.

Operation of Function Display Device

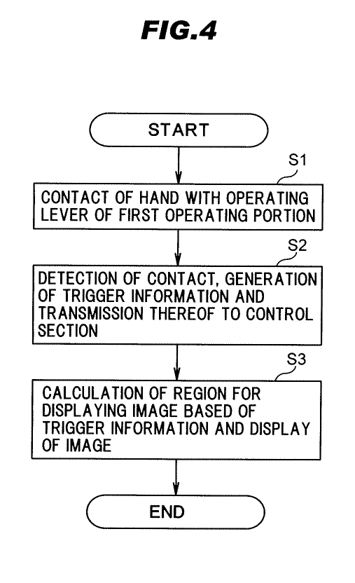

An operation of the function display device in the present embodiment will be explained as follows in conjunction with each drawing and the flow chart in FIG. 4.

Firstly, in order to operate the first operating portion 3, the operator brings the first operating portion 3 into visual field 9 and performs movement of touching the operating lever 30 by a hand (S1).

The trigger information generating portion 6 of the function display device 2 detects the contact of the hand to the operating lever 30, and generates and transmits trigger information to the control section 8 (S2).

The control section 8 of the function display device 2 calculates a region on the display portion 7 easily visible from the operator based on the trigger information received, and makes an image of “audio” displayed in the calculated first region 70 of the display portion 7 since the electronic device operable by the first operating portion 3 is an audio device (S3).

Although the above-mentioned operation of the function display device 2 is for the first operating portion 3, it is same with regard to the second operating portion 4 and the lever control switch 5. In addition, since the trigger information generating portion 6 detects variation of the operative portion in addition to the detection of the approach and contact of the hand and generates the trigger information as described above, the control section 8 makes the image corresponding to the operative position displayed in the region easily visible from the operator based on the trigger information.

### EFFECT OF THE FIRST EMBODIMENT

According to the function display device in the first embodiment, the following effects can be obtained.

(1) Since the function display device can display the functions allocated to each operating portion on the display portion by the approach or contact of the hand to each operating portion, it is possible to suppress movement of eyes of the operator.
(2) Since the function display device displays an image indicating a function in a region of the display portion within a visual field when viewing an operating lever, the function of the operating portion can be visible with less eye movement.

### Second Embodiment

The second embodiment of the invention will be explained hereinafter. The second embodiment is different from the first embodiment in that the trigger information generating portion is further provided on the base of the steering. The detailed explanations will be omitted for the portions which have the same functions and configurations as the first embodiment.

Structure of Function Display Device

The function display device 2 in the present embodiment further includes a left touchpad 122 and a right touchpad 123, which are composed of a non-contact sensor for detecting the approach and contact of the hand, as a trigger information generating portion 6 on, e.g., right and left of the base 120 of the steering 12.

Operation of Function Display Device

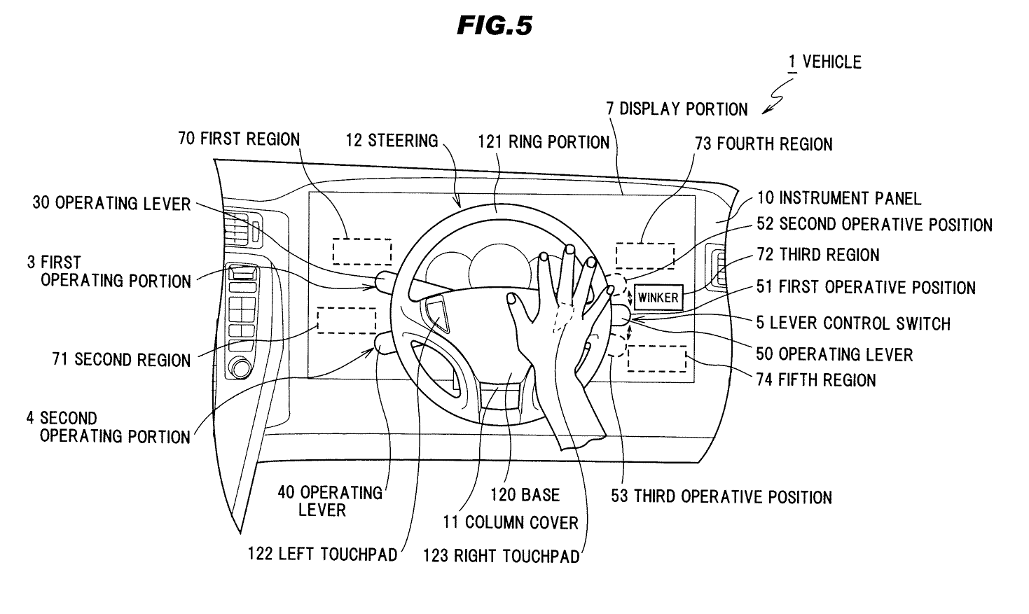

FIG. 5 is a schematic view showing inside of a vehicle in the second embodiment of the invention.

As shown in FIG. 5, the hand of the operator touches the right touchpad 123 of the steering 12 which is close to the lever control switch 5 to be operated.

The trigger information generating portion 6 generates trigger information for displaying the main functions of the lever control switch 5 based on the contact of the hand to the right touchpad 123, and transmits the trigger information to the control section 8.

The control section 8 makes an image indicating the function of the lever control switch 5 displayed in the third region 72 based on the trigger information.

### EFFECT OF THE SECOND EMBODIMENT

According to the function display device in the second embodiment, the following effects can be obtained.

Since the function display device can display the function of the operating portion in a region of the display portion easily visible from the operator not only by the contact of the hand to each operating lever but also by the contact of the hand to the touchpad provided in the vicinity of the operating portion of the desired operation, it is possible to reduce the eye movement.

### Other Embodiments

Although the above-mentioned display portion 7 is provided in the vicinity of the steering 12, the function display device 2 may display an image of the function corresponding to an operating portion on a head-up display which projects the image on the windshield of the vehicle 1.

The function display device 2 may have plural switches provided on the base 120 of the steering 12 and may display an image corresponding to the function of the switch in an easily visible region of the display portion 7 by generating trigger information by the contact of the hand to the switch. Alternatively, the function display device 2 may be configured to move the region to an easily visible position based on the rotational operation of the steering 12.

In addition, the left touchpad 122 and the right touchpad 123 are not limited to the non-contact sensor, and may be a pressure sensor and a switch, etc., which can detect the contact.

Although each operating portion is provided around the steering 12, it is not limited thereto. Hence, even when the operating portion and the display portion 7 do not exist in a visual field range of the operator, the function display device 2 can display the image in the region easily visible from the operator based on, e.g., the contact of the hand to the operating portion.

When the vehicle 1 is provided with a mechanism to calculate the eye position of the operator, the function display device 2 may move the region for displaying the image by using the mechanism based on the variation of the visual field 9 of the operator.

It should be noted that the present invention is not intended to be limited to the above-mentioned embodiments, and the various kinds of modifications and combinations can be implemented without departing from or changing the gist of the present invention.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A function display device, comprising:
an operating portion;
a display portion for displaying a function operable by the operating portion;
a trigger information generating portion that generates trigger information for displaying the function on the display portion based on movement of an operator with respect to the operating portion; and
a control section for controlling the display portion based on the generated trigger information so as to display the function in a region of the display portion easily visible from the operator.

2. The function display device according to claim 1, wherein the movement of the operator with respect to the operating portion includes approach and contact of a hand to the operating portion.

3. The function display device according to claim 1, wherein the operation portion comprises a plurality of functions corresponding to operative positions;
the trigger information generating portion generates the trigger information corresponding to the operative position of the operating portion; and
the control section allows a function corresponding to the operative position to be displayed in the region of the display portion based on the generated trigger information.

4. An on-vehicle function display device, comprising:
an operating portion on a periphery of a driver's seat in a vehicle;
a display portion for displaying a function operable by the operating portion;
a trigger information generating portion that generates trigger information for displaying the function on the display portion based on movement of an operator with respect to the operating portion; and
a control section for controlling the display portion based on the generated trigger information so as to display the function in a region of the display portion easily visible from the operator.

5. The on-vehicle function display device according to claim 4, wherein the movement of the operator with respect to the operating portion includes approach and contact of a hand to the operating portion.

6. The on-vehicle function display device according to claim 4, wherein the operation portion has a plurality of functions corresponding to operative positions;
the trigger information generating portion generates the trigger information corresponding to the operative position of the operating portion; and
the control section allows a function corresponding to the operative position to be displayed in the region of the display portion based on the generated trigger information.

7. The on-vehicle function display device according to claim 4, wherein the display portion is disposed in an instrument panel.

8. The on-vehicle function display device according to claim 4, wherein the display portion is disposed in a head-up display.

9. The on-vehicle function display device according to claim 4, wherein the trigger information generating portion is disposed on an operating means that is attached to a steering column cover.

10. The on-vehicle function display device according to claim 4, wherein the trigger information generating portion is disposed on a steering base.
